(19) United States
(12) Patent Application Publication
(10) Pub. No.: US 2006/0013993 A1
(43) Pub. Date: Jan. 19, 2006

(54) Article releasing a fragrance and including a lenticular image

(76) Inventors: Rony Havive, Oak Park, CA (US); Bryan N. Desure, Oak Park, CA (US)

Correspondence Address: LAW OFFICES OF ERIC KARICH, 2807 ST. MARK DR., MANSFIELD, TX, 76063, US

(21) Appl. No.: 10/891,879

(22) Filed: Jul. 15, 2004

(51) Int. Cl. B32B 3/10

(52) U.S. Cl. 428/131; 428/156; 428/167; 428/203

(57) ABSTRACT

An article is disclosed including a substantially rigid, porous substrate having two opposed surfaces and a volatile liquid fragrance dispersed therein, and a lenticular image formed on a corresponding one of the two opposed surfaces of the substrate.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to aromatic articles, and more particularly to decorative aromatic articles.

2. Description of Related Art

Researchers continue to discover the reasons behind the link between human senses and memory. In particular, the sense of smell has long been hailed the “memory sense,” the sense most likely to provoke reminiscence. The phenomenon that a familiar smell has the power to conjure up a detailed images of the past is common. Patients with brain damage can reportedly have amnesia stretching back several years, but still recall smells from their childhood.

Lenticular images produce eye-catching animations or three-dimensional (3-D) effects without the need for special viewers. A typical lenticular image includes a composite image and an overlying transparent plastic lens sheet. The composite image includes alternating portions of two or more images. The lens sheet allows the viewer to see a single one of the images dependent upon an orientation of the lenticular image with respect to the viewer. As the viewer moves (e.g., rotates) the lenticular image, the viewer sees different ones of the images in succession.

The eye-catching nature of lenticular images reflects their ability to greatly stimulate the sense of sight. The link between sight and memory is also significant. It would thus be advantageous to have an article that stimulates the senses of smell and sight simultaneously. Such an article would be a delightful novelty, and may also be used to provoke reminiscence.

### SUMMARY OF THE INVENTION

An article is disclosed including a substantially rigid, porous substrate having two opposed surfaces and a volatile liquid fragrance dispersed therein, and a lenticular image formed on a corresponding one of the two opposed surfaces of the substrate.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a front view of an article as seen from a particular viewing angle;

FIG. 2 is a cross-sectional view of the article of FIG. 1 as indicated in FIG. 1;

FIG. 3A is a perspective view of the components of the article of FIGS. 1 and 2 during the making of a hanging air freshener embodiment of the article;

FIG. 3B is a front elevation view of the completed hanging air freshener embodiment of the article of FIG. 3A;

FIG. 4A is a perspective view of the components of the article of FIGS. 1 and 2 during the making of a greeting card embodiment of the article; and

FIG. 4B is a perspective view of the greeting card embodiment of the article of FIG. 4A illustrating a folding operation.

### DETAILED DESCRIPTION OF THE INVENTION

FIG. 1 is a front view of an article 10 as seen from a particular viewing angle. As described in detail below, the article 10 has the ability to stimulate the senses of smell and sight simultaneously. Due to the link between human senses and memory, the article 10 may be used to provoke reminiscence. In the embodiment of FIG. 1, the article 10 may be, for example, a hanging air freshener, or a card such as a greeting card, a post card, or a business card. In FIG. 1 the article 10 has an optional hole 12 passing therethrough for hanging the article 10.

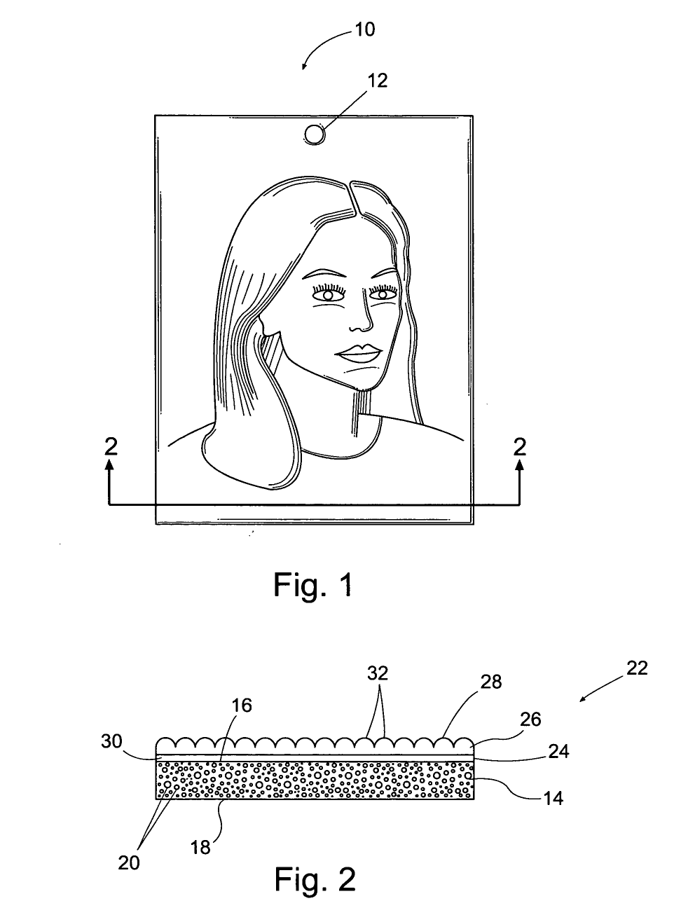

FIG. 2 is a cross-sectional view of the article 10 of FIG. 1 as indicated in FIG. 1. In the embodiment of FIG. 2, the article 10 includes a substantially rigid, porous substrate 14 having an upper surface 16 and an opposed underside surface 18. In FIGS. 1 and 2 the two opposed surfaces 16 and 18 are substantially rectangular. The porous substrate 14 may be made of or include, for example, cellulose fiber. In one example, the porous substrate 14 is a sheet of card stock paper.

The porous substrate 14 has voids or pores 20 dispersed therein, and a volatile liquid fragrance is introduced into at least some of the pores 20. When the article 10 is exposed to the atmosphere, the article 10 releases the fragrance at a gradual rate. The volatile liquid fragrance may be, for example, a fragrance oil or an essential oil.

The article 10 has a lenticular image 22 formed on the upper surface 16 of the substrate 14. In general, the lenticular image 22 includes a composite image 24 fixedly positioned between the upper surface 16 of the substrate 14 and an overlying transparent lens sheet 30. In the, embodiments of FIGS. 1 and 2, the composite image 24 is made of ink, and the ink is printed on the upper surface 16 of the substrate 14. In other embodiments, the ink may be printed (in reverse) directly on an underside surface 34 of the transparent lens sheet 30. In yet other embodiments, the composite image 24 may include a separate carrier substrate positioned between the substrate 14 and the lens sheet 30.

In general terms selected to cover all of the above possible forms of the composite image 24, the composite image 24 is characterized as having an upper surface 26 and an opposed underside surface 28. The underside surface 28 of the composite image 24 is attached to the upper surface 16 of the substrate 14, and the upper surface 26 of the composite image 24 is attached to the underside surface 34 of the lens sheet 30.

According to a common method of forming lenticular images, the composite image 24 includes alternating strips of two or more images. An upper surface 32 of the transparent lens sheet 30 has multiple parallel lenticular ridges 36 forming lens elements. The lens sheet 30 may be formed from, for example, a plastic material substantially transparent to visible light. In common fashion, the alternating strips of the images are spaced in optical registry with the lenticular ridges 36. Relative movement between a viewer of the lenticular image 22 and the article 10 causes the viewer to see different ones of the images, preferably only one image at a time.

In general, the images may be graphic images or photographs. The images may be, for example, of one or more subjects in different positions, and relative movement between the viewer and the article 10 may cause the viewer to see the one or more subjects move between the different positions. Alternately, the images may be of one or more subjects in a static position from different points of view, and relative movement between the viewer and the article 10 may give the image a three-dimensional effect.

In the embodiment of FIG. 2, the lenticular ridges 36 of the lens sheet 30 are oriented vertically with respect to the article 10 and the composite-image 24. It is noted that in other embodiments, the lenticular ridges 36 may be oriented horizontally with respect to the article 10 and the composite image 24. It is also noted that a second lenticular image may be formed on the underside surface 18 of the substrate 14.

FIGS. 3A and 3B will now be used to illustrate one method of making a hanging air freshener embodiment of the article 10 of FIGS. 1 and 2. FIG. 3A is a perspective view of the components of the article 10 during the making of the hanging air freshener embodiment. The volatile liquid fragrance, labeled 40 in FIG. 3A, is introduced into at least some of the pores of the porous substrate 14 as described above.

In the embodiment of FIG. 3A, the composite image 24 is made of ink, and the ink is printed on the upper surface 16 of the substrate 14. As noted above, the ink may be printed (in reverse) directly on an underside surface of the transparent lens sheet 30, or the composite image 24 may be formed on a separate carrier substrate positioned between the substrate 14 and the lens sheet 30. In general, the underside surface 28 of the composite image 24 is attached to the upper surface 16 of the substrate 14.

As indicated in FIG. 3A, an adhesive 42 is used to attach the underside surface 34 of the transparent lens sheet 30 to the upper surface 26 of the composite image 24. It is noted that where the composite image 24 is formed on a separate carrier substrate, the adhesive 42 may also be used to attach the underside surface 28 of the composite image 24 to the upper surface 16 of the substrate 14.

FIG. 3B is a front elevation view of the completed hanging air freshener embodiment of the article 10 of FIG. 3A. In FIG. 3B the hole 12 shown in FIG. 1 and described above has been formed through the article 10, and a loop of string 44 has been passed through the hole 12 for hanging.

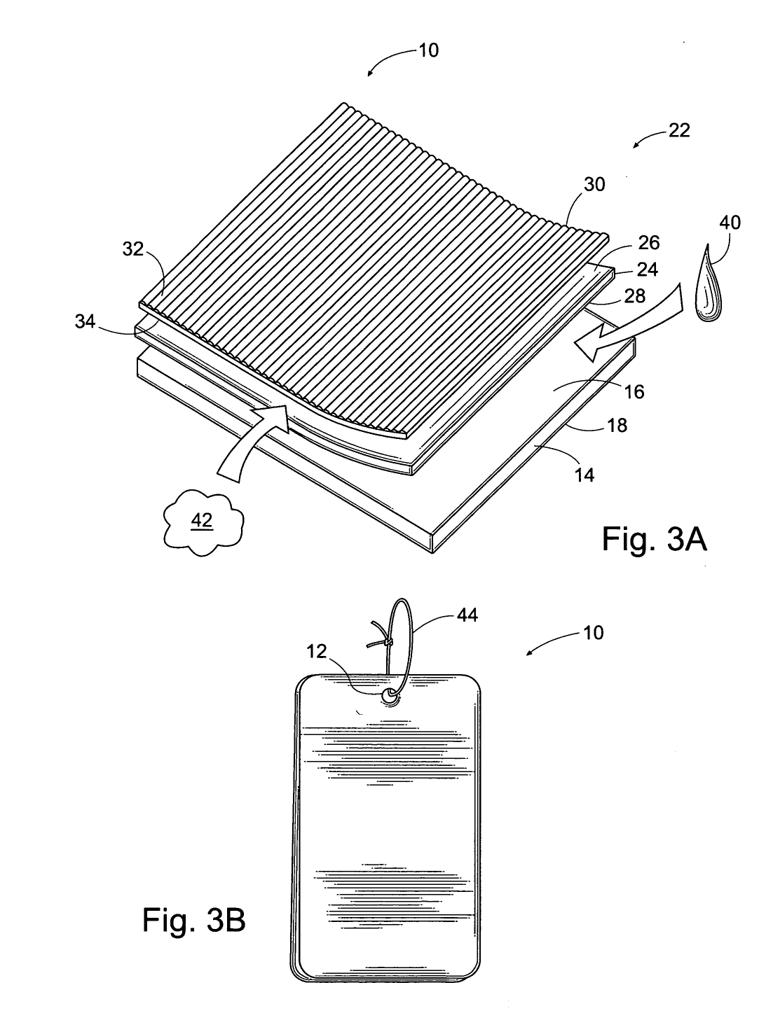

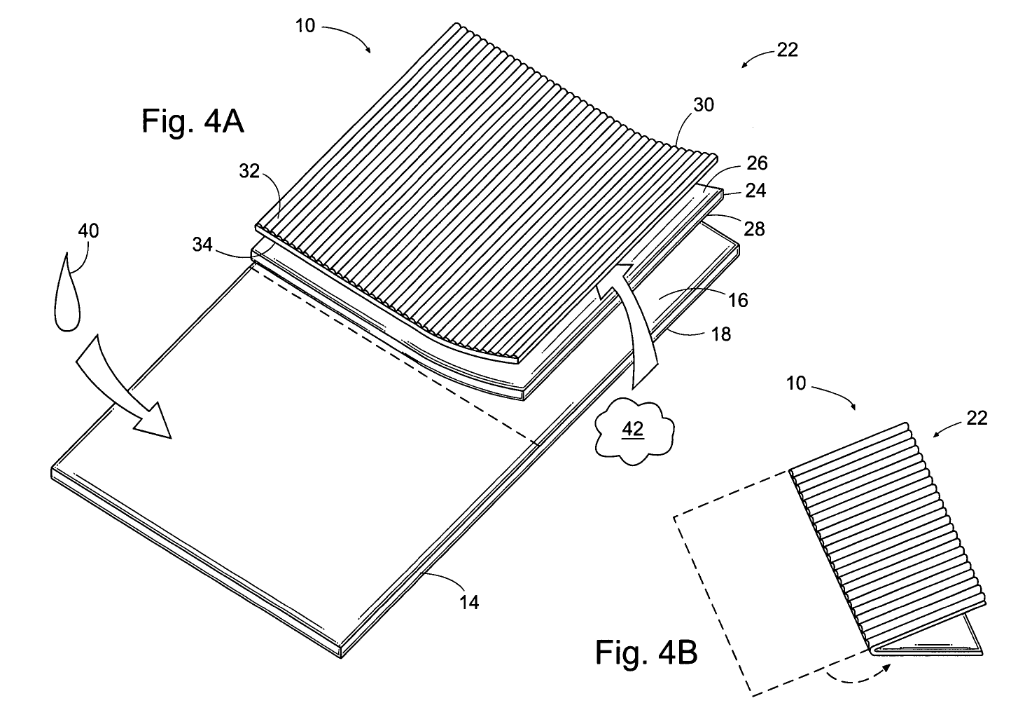

FIGS. 4A and 4B will now be used to illustrate one method of making a greeting card embodiment of the article 10 of FIGS. 1 and 2. FIG. 4A is a perspective view of the components of the article 10 during the making of the greeting card. The volatile liquid fragrance 40 is introduced into at least some of the pores of the porous substrate 14 as described above.

In the embodiment of FIG. 4A, the composite image 24 is made of ink, and the ink is printed on the upper surface 16 of the substrate 14. As noted above, the ink may be printed (in reverse) directly on an underside surface of the transparent lens sheet 30, or the composite image 24 may be formed on a separate carrier substrate positioned between the substrate 14 and the lens sheet 30. In general, the underside surface 28 of the composite image 24 is attached to the upper surface 16 of the substrate 14.

As indicated in FIG. 4A, the adhesive 42 is used to attach the underside surface 34 of the transparent lens sheet 30 to the upper surface 26 of the composite image 24. It is noted that where the composite image 24 is formed on a separate carrier substrate, the adhesive 42 may also be used to attach the underside surface 28 of the composite image 24 to the upper surface 16 of the substrate 14.

FIG. 4B is a perspective view of the greeting card embodiment of the article 10 of FIG. 4A illustrating a folding operation. In FIG. 4A a leftmost half of the substrate 14 is folded under the rightmost half. As a result, the lenticular image 22 is positioned on a front portion of the greeting card.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An article, comprising:
a substantially rigid, porous substrate having two opposed surfaces and a volatile liquid fragrance dispersed therein; and
a lenticular image formed on a corresponding one of the two opposed surfaces of the substrate.

2. The article as recited in claim 1, wherein the article is a card.

3. The article as recited in claim 1, wherein the substrate comprises cellulose fiber.

4. The article as recited in claim 1, wherein when the article is exposed to the atmosphere, the article releases the fragrance at a gradual rate.

5. The article as recited in claim 1, wherein the volatile liquid fragrance comprises a fragrance oil or an essential oil.

6. The article as recited in claim 1, wherein the two opposed surfaces of the substrate are substantially rectangular.

7. The article as recited in claim 1, wherein the substrate has a hole passing therethrough for hanging the article.

8. The article as recited in claim 1, wherein the lenticular image comprises:
a composite image formed on the corresponding surface of the substrate, the composite image comprising alternating strips of a plurality of images; and
a transparent lens sheet having opposed upper and underside surfaces, wherein the underside surface is in contact with the composite image, and wherein the upper surface comprises a plurality of parallel lenticular ridges forming lens elements.

9. The article as recited in claim 8, wherein the alternating strips of the images are spaced in optical registry with the lenticular ridges.

10. The article as recited in claim 8, wherein relative movement between a viewer of the lenticular image and the article causes the viewer to see different ones of the plurality of images.

11. The article as recited in claim 8, wherein the plurality of images are of at least one subject in different positions.

12. The article as recited in claim 8, wherein the plurality of images are of at least one subject in a static position from different points of view.

13. An article, comprising:
a substantially rigid, porous substrate having two opposed surfaces and a volatile liquid fragrance dispersed therein;
a lenticular image formed on a corresponding one of the two opposed surfaces of the substrate, the lenticular image comprising:
a composite image formed on the corresponding surface of the substrate, wherein the composite image comprises alternating strips of a plurality of images; and
a transparent lens sheet having opposed upper and underside surfaces, wherein the underside surface is in contact with the composite image, and wherein the upper surface comprises a plurality of parallel lenticular ridges forming lens elements.

14. The article as recited in claim 13, wherein the article is a card.

15. The article as recited in claim 13, wherein the substrate comprises cellulose fiber.

16. The article as recited in claim 13, wherein when the article is exposed to the atmosphere, the article releases the fragrance at a gradual rate.

17. The article as recited in claim 13, wherein the volatile liquid fragrance comprises a fragrance oil or an essential oil.
